(19) United States
(12) Patent Application Publication
(10) Pub. No.: US 2010/0164439 A1
(43) Pub. Date: Jul. 1, 2010

(54) CHARGING CONTROL DEVICE, METHOD, AND PROGRAM

(75) Inventor: Yusaku Ido, Kani-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/645,682

(22) Filed: Dec. 23, 2009

(30) Foreign Application Priority Data
Dec. 25, 2008 (JP) 2008-329682

(51) Int. Cl. H02J 7/04

(52) U.S. Cl. 320/155; 180/65.29

(57) ABSTRACT

This invention aims to more appropriately perform reserved charging of a battery, which is a power source of a vehicle. A necessary capacity calculation unit obtains a necessary capacity, which is a necessary capacity of the battery, based on at least one of an average traveling distance of the vehicle and an average consuming amount of the battery for a predetermined time. A charging time calculation unit obtains a time necessary for charging from a currently remaining amount of the battery to the necessary capacity as a charging time. A reserved time setting unit sets a charging start time of the battery between a current time and a time in which the charging time is subtracted from a use start time set by a user, and sets a time the charging time elapsed from the charging start time as a charging end time. A charging control unit controls to charge the battery from the set charging start time to the charging end time. The present invention can be applied to a charging control device of an electrical vehicle.

### BACKGROUND OF THE INVENTION

1. Technical Field

The present invention relates to charging control devices and methods, as well as programs, in particular, to a charging control device and a method, as well as a program suitably used when performing reserved charging of a battery, which is a power source of a vehicle.

2. Related Art

Conventionally, setting an arbitrary day of a week or a date and time to perform reserved charging of a battery of a forklift has been proposed (see e.g., Japanese Unexamined Patent Publication No. 2002-90485).

Furthermore, starting the charging of the battery from a time in which a time required for full charging of the battery is subtracted from a use start scheduled time of an electrical vehicle is conventionally proposed (see e.g., Japanese Unexamined Patent Publication No. 10-262305 or Japanese Patent No. 3554057).

### SUMMARY

However, in the invention described in Japanese Unexamined Patent Publication No. 2002-90485, only a day of a week or a date and time to start charging can be set, and a charging capacity cannot be specified.

In the inventions described in Japanese Unexamined Patent Publication No. 10-262305 and Japanese Patent No. 3554057, only reservation of full charging can be performed.

The present invention has been devised to solve the problems described above, and an object thereof is to enable reserved charging of a battery, which is a power source of a vehicle, more appropriately.

### BRIEF DESCRIPTION OF THE DRAWINGS

FIG. 1 is a block diagram showing an example of configurations of circuits at a periphery of a battery of a vehicle mounted with a BMU applied with the present invention;

FIG. 2 is a block diagram showing a functional configuration of the BMU;

FIG. 3 is a flowchart describing a charging process executed by the vehicle applied with the present invention;

FIG. 4 is a flowchart describing a charging process executed by the vehicle applied with the present invention;

FIG. 5 is a view showing one example of a charging state display screen;

FIG. 6 is a view showing one example of a charging mode setting screen;

FIG. 7 is a flowchart describing details of a manual timer reserved charging setting process;

FIG. 8 is a view showing one example of a manual timer reserved charging setting screen;

FIG. 9 is a flowchart describing details of a normal timer reserved charging setting process;

FIG. 10 is a view showing one example of a normal timer reserved charging setting screen;

FIG. 11 is a flowchart describing details of a fixed charge fee timer reserved charging setting process;

FIG. 12 is a view showing one example of a fixed charge fee timer reserved charging setting screen;

FIG. 13 is a flowchart describing details of a reservation time setting process; and

FIG. 14 is a flowchart describing details of the reservation time setting process.

### DETAILED DESCRIPTION

Hereinafter, preferred embodiments of the present invention will be described with reference to the drawings.

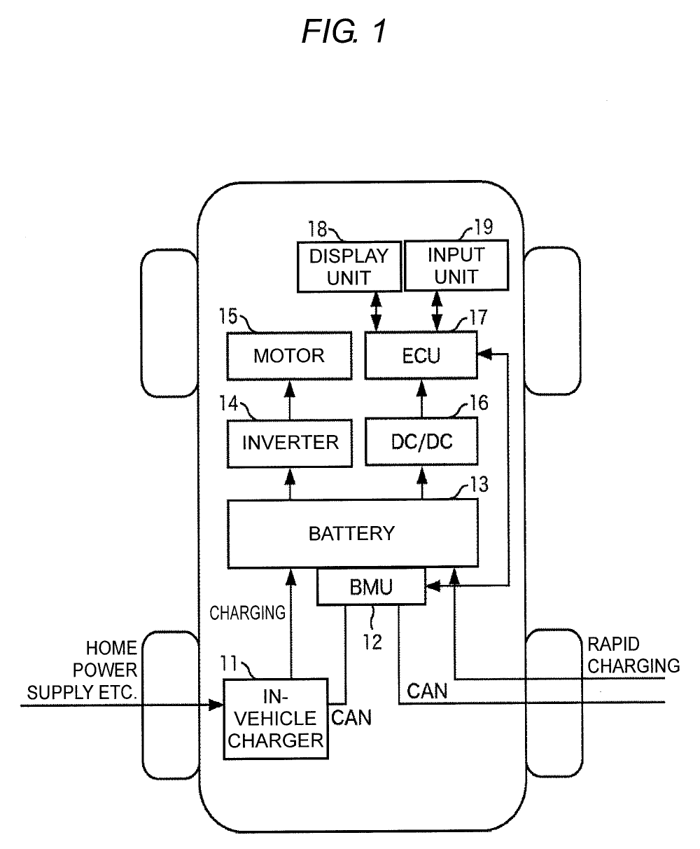

FIG. 1 shows an example of configurations of circuits at a periphery of a battery of a vehicle mounted with a BMU (Battery Management Unit) applied with the present invention.

A vehicle 1 of FIG. 1 is an electrical vehicle having a battery 13 as a power source. The battery 13 of the vehicle 1 can be charged through two types of charging methods, rapid charging and normal charging. The rapid charging is a charging method of connecting the battery 13 of the vehicle 1 to a dedicated rapid charging device (not shown) and performing charging in a short period of time. The normal charging is a charging method of connecting an in-vehicle charger 11 of the vehicle 1 to a standard outlet in general households and offices through a dedicated charging cable, and having the in-vehicle charger 11 perform the charging of the battery 13 using power supplied from a power supply at a destination of the connected outlet.

A BMU 12 performs communication complying with a CAN (Controller Area Network) with the in-vehicle charger 11 and the rapid charging device, and controls the normal charging and the rapid charging of the battery 13. The BMU 12 also performs the communication complying with the CAN with other in-vehicle components of the vehicle 1 such as an ECU 17.

The power of the battery 13 is converted from DC (Direct Current) to AC (Alternating Current) by an inverter 14, and supplied to a motor 15 for driving the traveling of the vehicle 1. The power of the battery 13 is also converted to a predetermined voltage by a DC/DC converter (hereinafter referred to as DC/DC), and supplied to the in-vehicle components driven by the DC power such as the ECU (Electronic Control Unit or Engine Control Unit) 17.

A display unit 18 is configured by a monitor of a car navigation device, an installment panel, a dedicated monitor, or the like, and displays various types of information based the control of the ECU 17.

An input unit 19 is configured by an input device such as various types of switches, buttons, keys, and the like. The user operates the input unit 19 to give various types of instructions to the ECU 17. The ECU 17 provides the given instruction to other in-vehicle components such as the BMU 12, or controls other in-vehicle components based on the given instruction, as necessary.

Although not illustrated, the display unit 18 and the input unit 19 also operate using the power of the battery 13.

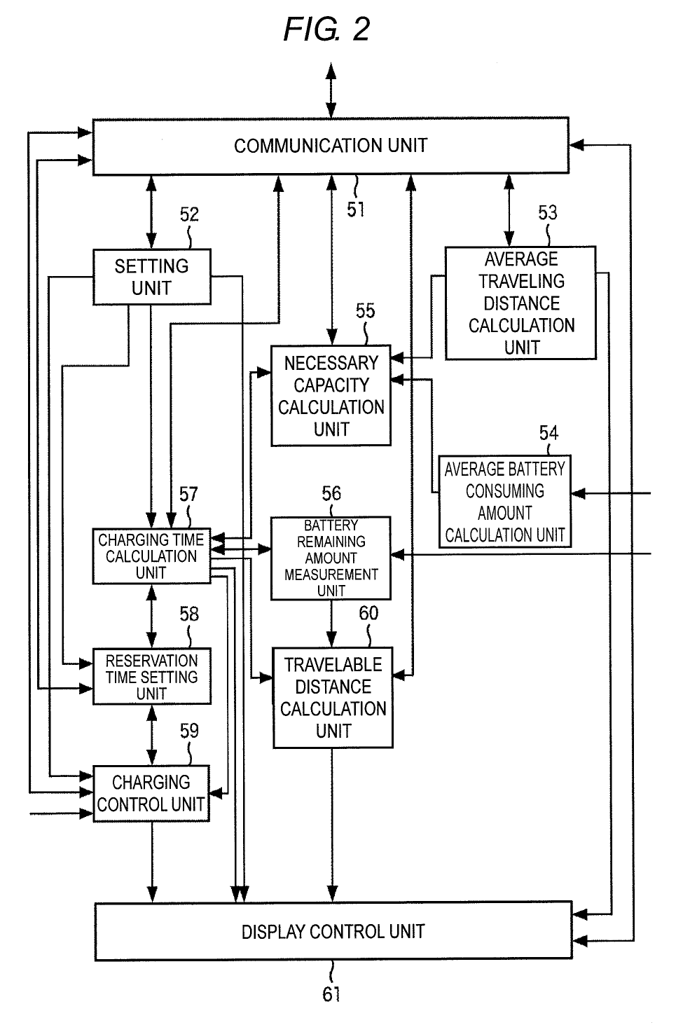

FIG. 2 is a block diagram showing a functional configuration of the BMU 12. The BMU 12 is configured to include a communication unit 51, a setting unit 52, an average traveling distance calculation unit 53, an average battery consuming amount calculation unit 54, a necessary capacity calculation unit 55, a battery remaining amount measurement unit 56, a charging time calculation unit 57, a reservation time setting unit 58, a charging control unit 59, a travelable distance calculation unit 60, and a display control unit 61.

The communication unit 51 is configured by a communication device that performs the communication complying with the CAN (Controller Area Network), and communicates with in-vehicle components of the vehicle 1 such as the in-vehicle charger 11 and the ECU 17, as well as, devices outside the vehicle connected to the vehicle 1 such as the rapid charging device (not shown). The communication unit 51 transmits and receives information with the setting unit 52, the average traveling distance calculation unit 53, the necessary capacity calculation unit 55, the charging time calculation unit 57, the reservation time setting unit 58, the charging control unit 59, the travelable distance calculation unit 60, and the display control unit 61.

The setting unit 52 performs various types of settings related to the charging of the battery 13 according to an instruction from a user inputted through the input unit 19, the ECU 17, and the communication unit 51, and notifies the set content to the charging time calculation unit 57, the reservation time setting unit 58, the charging control unit 59, and the display control unit 61. Items set by the setting unit 52 include a charging mode and a late-night power setting.

The charging mode indicates a method of reserved charging of the battery 13, and has four types, a manual timer reserved charging mode, a normal timer reserved charging mode, a fixed charge fee timer reserved charging mode, and a forced charging mode.

The manual timer reserved charging mode is a mode of fully charging the battery 13 before a specified time.

The normal timer reserved charging mode is a mode of obtaining the necessary capacity of the battery 13 based on the average traveling distance and the average battery consuming amount of the vehicle 1, and charging the battery 13 up to the necessary capacity before the set time.

The fixed charge fee timer reserved charging mode is a mode of charging the battery 13 within a range of the charge fee set before the set time.

The forced charging mode is a mode of immediately starting the charging of the battery 13 without specifying the time.

The late-night power setting is a setting item for specifying whether or not to perform charging preferentially in a late-night power time zone in which the inexpensive late-night power rate is applied.

The setting unit 52 instructs setting and processes related to reserving the charging of the battery 13, and execution of the reservation, and the like to the charging time calculation unit 57, the reservation time setting unit 58, the charging control unit 59, and the display control unit 61.

The average traveling distance calculation unit 53 acquires information on the traveling distance of the vehicle 1 from the ECU 17 through the communication unit 51 at a predetermined timing, and records the same with a date and time. The average traveling distance calculation unit 53 also calculates the average traveling distance of the vehicle 1 for a predetermined time based on the recorded information according to the instruction from the necessary capacity calculation unit 55. The average traveling distance calculation unit 53 notifies the obtained average traveling distance to the necessary capacity calculation unit 55.

The average battery consuming amount calculation unit 54 monitors the state of the battery 13, and records the consuming amount of the battery 13 with the date and time. The average battery consuming amount calculation unit 54 also calculates the average battery consuming amount indicating the average of the consuming amount of the battery 13 for a predetermined time based on the recorded information according to the instruction from the necessary capacity calculation unit 55. The average battery consuming amount calculation unit 54 notifies the obtained average battery consuming amount to the necessary capacity calculation unit 55.

The necessary capacity calculation unit 55 acquires information on fuel consumption of the vehicle 1 from the ECU 17 through the communication unit 51. The necessary capacity calculation unit 55 calculates the capacity of the battery 13 necessary until the next charging based on the fuel consumption of the vehicle 1, and the average traveling distance and the average battery consuming amount of the vehicle 1 according to the instruction from the charging time calculation unit 57. The necessary capacity calculation unit 55 notifies the obtained capacity of the battery 13 to the charging time calculation unit 57.

The battery remaining amount measurement unit 56 measures the voltage and the temperature of the battery 13 according to the instruction from the charging time calculation unit 57 or at a predetermined timing, and measures the remaining amount of the battery 13 based on the measured voltage and temperature of the battery 13. The battery remaining amount measurement unit 56 notifies the measured remaining amount of the battery 13 to the charging time calculation unit 57 and the travelable distance calculation unit 60.

The charging time calculation unit 57 detects the connection state of the in-vehicle charger 11 and the power supply, and the connection state of the battery 13 and the rapid charging device (not shown) based on the signal externally inputted through the communication unit 51. The charging time calculation unit 57 calculates the charging time necessary for the charging of the battery 13 based on the detected connection state, the type of set charging mode, the necessary capacity of the battery 13 obtained by the necessary capacity calculation unit 55, the upper limit of the charge fee required for the charging of the battery set by the user, and the remaining amount of the battery 13. The charging time calculation unit 57 notifies the obtained charging time to the reservation time setting unit 58, the charging control unit 59, and the display control unit 61. The charging time calculation unit 57 corrects the obtained charging time according to the instruction from the reservation time setting unit 58, and notifies the corrected charging time to the reservation time setting unit 58 and the display control unit 61. Furthermore, the charging time calculation unit 57 calculates the capacity of the battery 13 after charging, and notifies the obtained capacity of the battery 13 after charging to the travelable distance calculation unit 60.

The reservation time setting unit 58 determines whether or not the in-vehicle charger 11 is connected to the home power supply based on the signal inputted from the in-vehicle charger 11 through the communication unit 51. As a result of the determination, the reservation time setting unit 58 sets the reservation time to perform reserved charging of the battery 13 based on the charging time obtained by the charging time calculation unit 57, the type of set charging mode, and the presence of late-night power setting. The reservation time setting unit 58 notifies the set reservation time to the charging control unit 59.

The charging control unit 59 monitors the connection state of the in-vehicle charger 11 and the power supply, and the connection state of the battery 13 and the rapid charging device (not shown) based on the signal externally inputted through the communication unit 51. The charging control unit 59 also monitors the voltage and the temperature of the battery 13. The charging control unit 59 also gives instructions to start and stop charging to the in-vehicle charger 11 and the rapid charging device through the communication unit 51, and controls the charging of the battery 13. The charging control unit 59 then notifies a progress state of charging to the display control unit 61.

The travelable distance calculation unit 60 acquires information on fuel consumption of the vehicle 1 from the ECU 17 through the communication unit 51. The travelable distance calculation unit 60 estimates the distance the vehicle 1 can travel with the currently remaining amount of the battery 13 based on the remaining amount of the battery 13 measured by the battery remaining amount measurement unit 56 and the fuel consumption of the vehicle 1, and notifies the estimated travelable distance to the display control unit 61. The travelable distance calculation unit 60 also estimates the distance the vehicle 1 can travel after charging based on the capacity of the battery 13 after charging obtained by the charging time calculation unit 57 and the fuel consumption of the vehicle 1, and notifies the estimated travelable distance to the display control unit 61.

The display control unit 61 gives an instruction to the ECU 17 through the communication unit 51 while acquiring necessary information from each unit of the BMU 12, and displays a screen showing the charging state of the battery 13, a screen for performing setting related to the charging of the battery 13, and the like on the display unit 18.

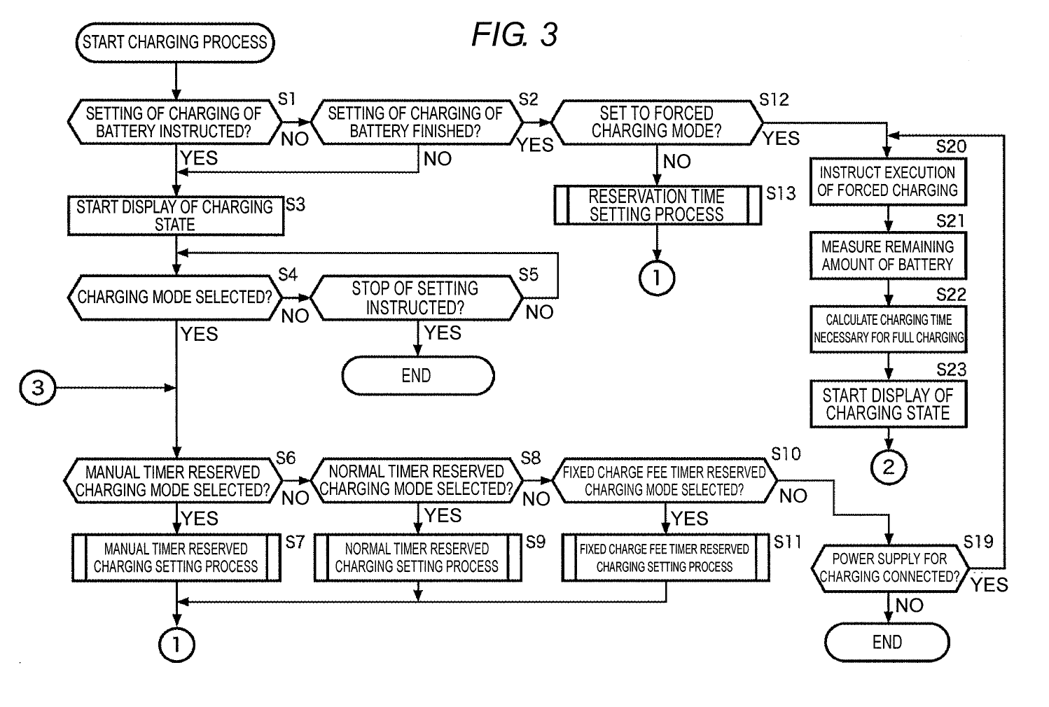

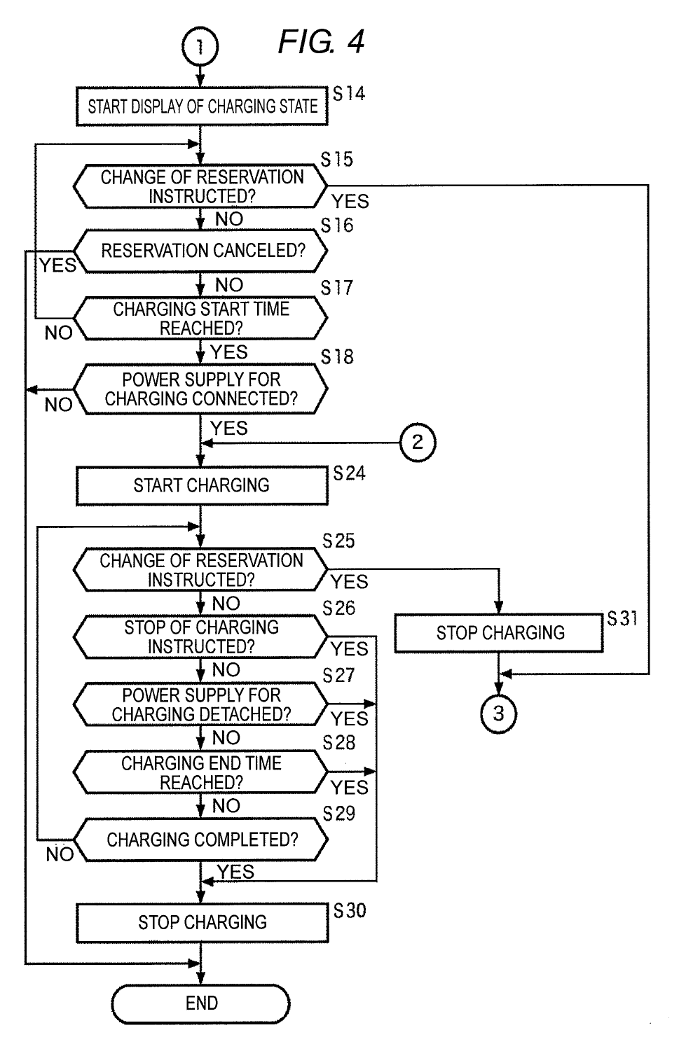

The charging process executed by the vehicle 1 will now be described with reference to flowcharts of FIGS. 3 and 4. The process starts when the power supply for charging is connected to the in-vehicle charger 11 through the charging cable or the rapid charging device is connected to the battery 13 through the charging cable and the charging of the battery 13 is enabled, or when the users inputs an instruction for the setting of the charging of the battery 13 through the input unit 19.

In step S1, the setting unit 52 determines whether or not the setting of the charging of the battery 13 is instructed. The process proceeds to step S2 if determined that the setting of the charging of the battery 13 is not instructed.

In step S2, the setting unit 52 determines whether or not the setting of the charging of the battery 13 is finished. The process proceeds to step S3 if determined that the setting of the charging of the battery 13 is not finished.

If, for example, the user inputs the instruction for the setting of the charging of the battery 13 through the input unit 19 so that such an instruction is provided to the setting unit 52 through the ECU 17 and the communication unit 51 in step S1, the setting unit 52 determines that the setting of the charging of the battery 13 is instructed, the process of step S2 is skipped and the process proceeds to step S3.

In step S3, the display unit 18 starts to display the charging state. Specifically, the setting unit 52 instructs the display control unit 61 to display the charging state of the battery 13. The display control unit 61 gives an instruction to the ECU 17 through the communication unit 51 while acquiring the necessary information from each unit of the BMU 12, and causes the display unit 18 to display a charging state display screen showing the charging state of the battery 13.

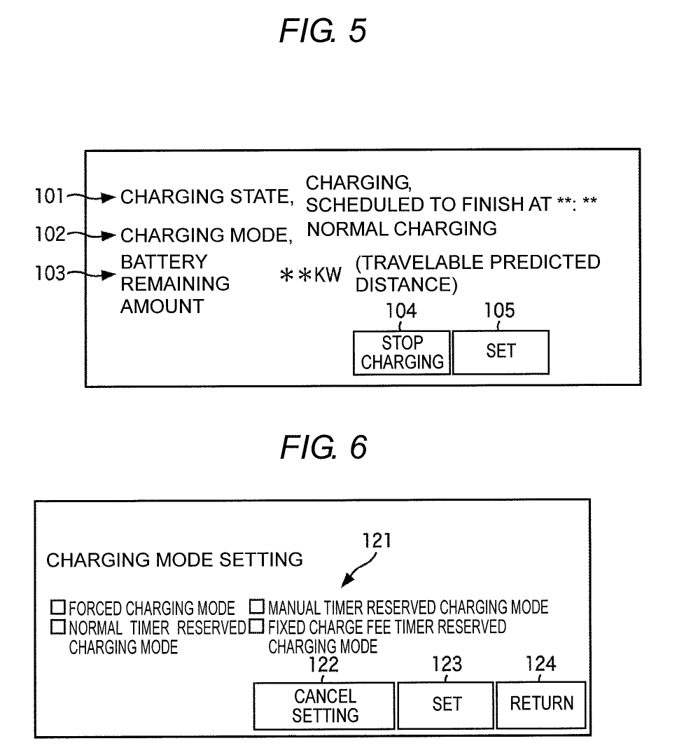

FIG. 5 shows one example of the charging state display screen. A charging state field 101, a charging mode field 102, a battery remaining amount field 103, a charging stop button 104, and a set button 105 are displayed on the charging state display screen of FIG. 5.

In the charging state field 101, whether or not the battery 13 is being charged is displayed, and if being charged, a scheduled time when the charging is to finish is further displayed.

In the charging mode field 102, the charging mode that is currently being set is displayed.

In the battery remaining amount field 103, the currently remaining amount of the battery 13 and a predicted value of the distance the vehicle 1 can travel with the remaining amount are displayed.

The charging stop button 104 is a button to be pushed when stopping the charging of the battery 13 or when finishing the setting of the charging.

The set button 105 is a button to be pushed when performing the setting of the charging of the battery 13.

FIG. 6 shows one example of a charging mode setting screen displayed when the set button 105 is pushed at the charging state display screen of FIG. 5. A charging mode setting field 121, a setting cancel button 122, a set button 123, and a return button 124 are displayed on the charging mode setting screen of FIG. 6.

In the charging mode setting field 121, checkboxes for selecting the charging mode desired by the user from the forced charging mode, the manual timer reserved charging mode, the normal timer reserved charging mode, and the fixed charge fee timer reserved charging mode are displayed.

The setting cancel button 122 is a button to be pushed when canceling the setting of the charging of the battery 13.

The set button 123 is a button to be pushed when confirming the charging mode selected in the charging mode setting field 121 and carrying out a detailed setting of the confirmed charging mode.

The return button 124 is a button to be pushed when returning to the previous charging state display screen of FIG. 5.

Although the detailed description will not be given, the display control unit 61 gives an instruction to the ECU 17 through the communication unit 51 while appropriately collecting information from each unit of the BMU 12 according to the instruction of the user inputted through the input unit 19, the ECU 17, and the communication unit 51 during the execution of the charging process, and executes switching or updating of the screen displayed on the display unit 18.

Returning back to FIG. 3, in step S4, the setting unit 52 determines whether or not the charging mode is selected. If determined that the charging mode is not selected, the process proceeds to step S5.

In step S5, the setting unit 52 determines whether stop of the setting is instructed. If determined that the stop of the setting is not instructed, the process returns to step S4, and the processes of steps S4 and S5 are repeatedly executed until it is determined that the charging mode is selected in step S4 or it is determined that the stop of the setting is instructed in step S5.

When, for example, the user operates the input unit 19 and pushes the charging stop button 104 on the charging state display screen of FIG. 5 or pushes the setting cancel button 122 on the charging mode setting screen of FIG. 6 so that the information is provided to the setting unit 52 from the ECU 17 through the communication unit 51 in step S5, the setting unit 52 determines that the stop of the setting is instructed and terminates the charging process. If the setting cancel button 122 is pushed, the setting unit 52 clears all currently set content.

When, for example, the user operates the input unit 19 and selects the charging mode in the charging mode setting field 121 on the charging mode setting screen of FIG. 6, and then pushes the set button 123 so that the information is provided to the setting unit 52 from the ECU 17 through the communication unit 51 in step S4, the setting unit 52 determines that the charging mode is selected and the process proceeds to step S6.

In step S6, the setting unit 52 determines whether the manual timer reserved charging mode is selected. The process proceeds to step S7 if determined that the manual timer reserved charging mode is selected.

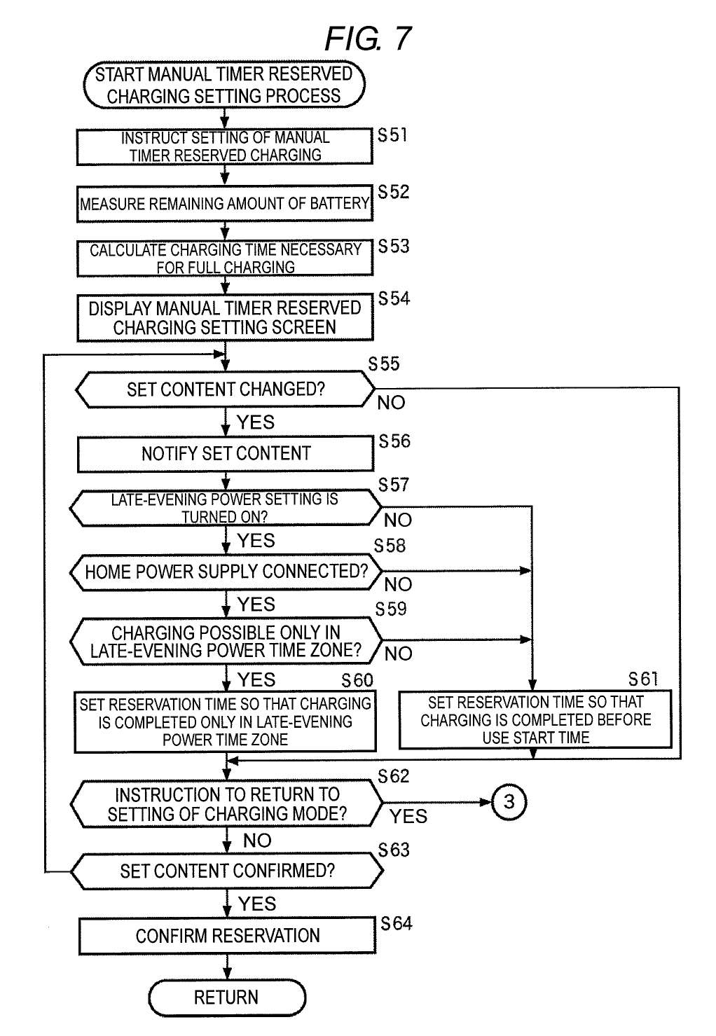

In step S7, the BMU 12 executes a manual timer reserved charging setting process. The details of the manual timer reserved charging setting process will be described later with reference to FIG. 7, but a reservation time of the charging of the battery 13 is set by such a process. The process then proceeds to step S14.

If determined that the manual timer reserved charging setting mode is not selected in step S7, the process proceeds to step S8.

In step S8, the setting unit 52 determines whether or not the normal timer reserved charging mode is selected. The process proceeds to step S9 if determined that the normal timer reserved charging mode is selected.

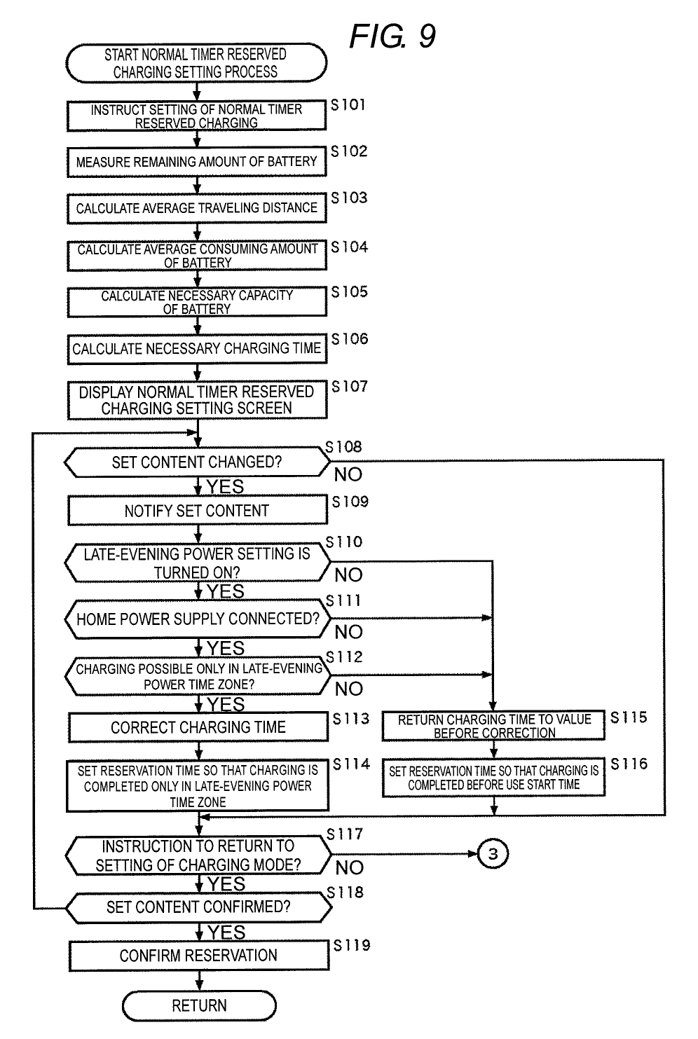

In step S9, the BMU 12 executes a normal timer reserved charging setting process. The details of the normal timer reserved charging setting process will be described later with reference to FIG. 9, but a reservation time of the charging of the battery 13 is set by such a process. The process then proceeds to step S14.

The process proceeds to step S10 if determined that the normal timer reserved charging mode is not selected.

In step S10, the setting unit 52 determines whether or not the fixed charge fee timer reserved charging mode is selected. The process proceeds to step S11 if determined that the fixed charge fee timer reserved charging mode is selected.

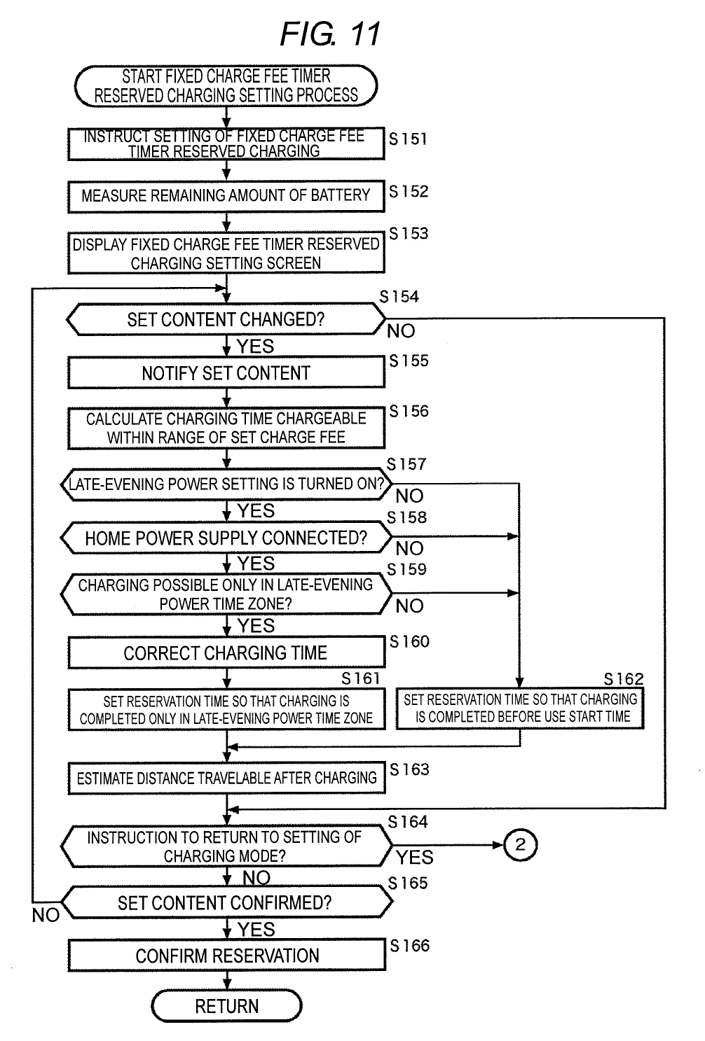

In step S11, the BMU 12 executes a fixed charge fee timer reserved charging setting process. The details of the normal timer reserved charging setting process will be described later with reference to FIG. 11, but a reservation time of the charging of the battery 13 is set by such a process. The process then proceeds to step S14.

If determined that the setting of the charging of the battery 13 is finished in step S2, the process proceeds to step S12.

In step S12, the setting unit 52 determines whether or not the forced charging mode is set. The process proceeds to step S13 if determined that the forced charging mode is not set.

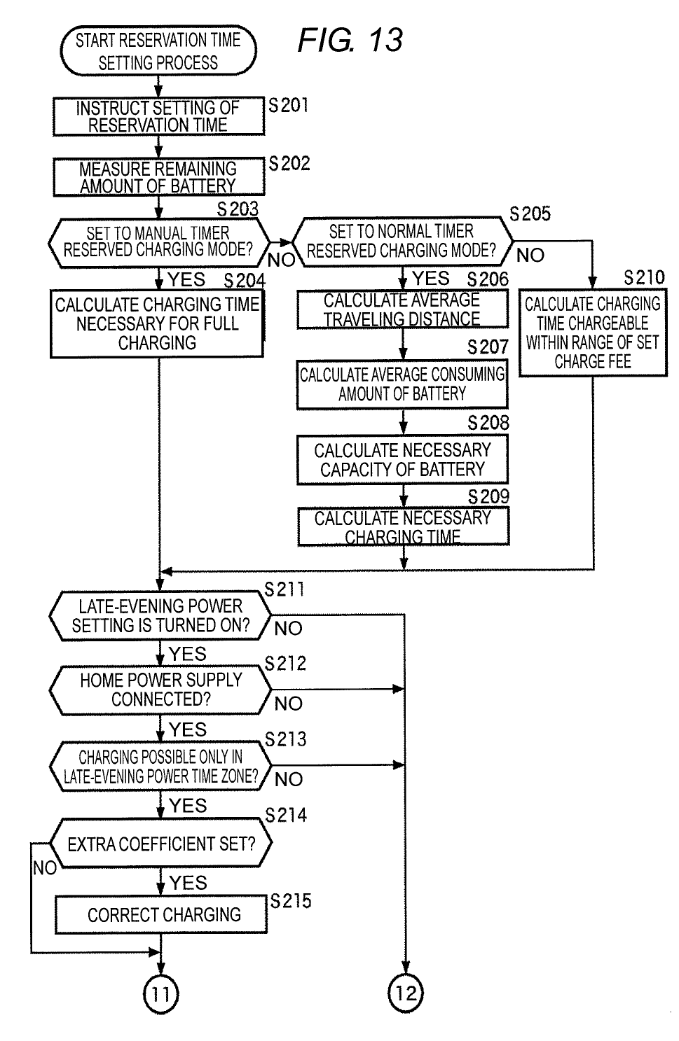

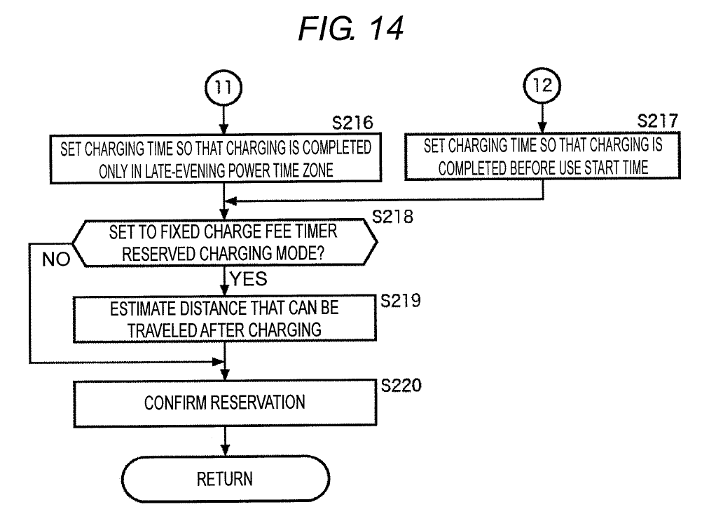

In step S13, the BMU 12 executes a reservation time setting process. The details of the reservation time setting process will be described later with reference to FIGS. 13 and 14, but a reservation time of the charging of the battery 13 is set by such a process. The process then proceeds to step S14.

In step S14, the display of the charging state starts, similar to the process of step S3.

In this case, if the power supply for charging is not connected, a notification urging the connection of the power supply for charging may be made using the display unit 18 and the like.

In step S15, the setting unit 52 determines whether or not change of reservation is instructed. The process proceeds to step S16 if determined that the change of reservation is not instructed.

In step S16, the setting unit 52 determines whether or not the reservation is canceled. The process proceeds to step S17 if determined that the reservation is not canceled.

In step S17, the charging control unit 59 determines whether the charging start time is reached. If determined that the charging start time is not reached, the process returns to step S15, and the processes of steps S15 to S17 are repeatedly executed until determined that the change of reservation is instructed in step S15, determined that the reservation is canceled in step S16, or determined that the charging start time is reached.

When, for example, the user operates the input unit 19 and selects the charging mode in the charging mode setting field 121 on the charging mode setting screen of FIG. 6 and then pushes the set button 123 so that the information is provided to the setting unit 52 from the ECU 17 through the communication unit 51 in step S15, the setting unit 52 determines that the change of reservation is instructed, and the process returns to step S6. The processes after step S6 are then executed.

When, for example, the user operates the input unit 19 and pushes the charging stop button 104 on the charging state display screen of FIG. 5 or pushes the setting cancel button 122 on the charging mode setting screen of FIG. 6 so that the information is provided to the setting unit 52 from the ECU 17 through the communication unit 51 in step S16, the setting unit 52 determines that the reservation is canceled and terminates the charging process. If the setting cancel button 122 is pushed, the setting unit 52 clears all currently set content.

Furthermore, if determined that the charging start time is reached in step S17, the process proceeds to step S18.

In step S18, the charging control unit 59 determines whether or not the power supply for charging is connected. The charging control unit 59 determines that the power supply for charging is not connected when both the state in which the power supply is connected to the in-vehicle charger 11 and the state in which the rapid charging device is connected to the battery 13 are not detected based on the signal externally inputted through the communication unit 51, and terminates the charging process.

If at least one of the state in which the power supply is connected to the in-vehicle charger 11 or the state in which the rapid charging device is connected to the battery 13 is detected in step S18, the charging control unit 59 determines that the power supply for charging is connected and the process proceeds to step S24.

If the power supply for charging is not connected in step S18, a notification urging the connection of the power supply for charging may be made using the display unit 18 and the like, and a final determination may be made at the time point a predetermined time has elapsed therefrom.

If determined that the fixed charge fee timer reserved charging mode is not selected in step S10 of FIG. 3, that is, if determined that the forced charging mode is selected, the process proceeds to step S19.

In step S19, the setting unit 52 determines whether or not the power supply for charging is connected, similar to the process of the charging control unit 59 of step S18. If determined that the power supply for charging is not connected, the charging process is terminated.

If determined that the power supply for charging is connected in step S19, the process proceeds to step S20.

If determined that the forced charging mode is set in step S12, the process proceeds to step S20.

In step S20, the setting unit 52 instructs the execution of the forced charging to the charging time calculation unit 57, the charging control unit 59, and the display control unit 61.

In step S21, the battery remaining amount calculation unit 56 measures the remaining amount of the battery 13. Specifically, the charging time calculation unit 57 instructs the battery remaining amount measurement unit 56 to measure the remaining amount of the battery 13. The battery remaining amount measurement unit 56 measures the voltage and the temperature of the battery 13, and measures the remaining amount of the battery 13 based on the measured voltage and the temperature of the battery 13. The battery remaining amount measurement unit 56 notifies the measured remaining amount of the battery 13 to the charging time calculation unit 57.

In step S22, the charging time calculation unit 57 calculates the charging time necessary for full charging. Specifically, the charging time calculation unit 57 first selects one of normal charging or rapid charging. Specifically, the normal charging is selected if a state in which the power supply is connected to the in-vehicle charger 11 is detected, and the rapid charging is selected if a state in which the rapid charging device is connected to the battery 13 is detected based on the signal externally inputted through the communication unit 51. The charging time calculation unit 57 selects one of the normal charging or the rapid charging according to a predetermined priority or the selection by the user if a state in which the power supply is connected to the in-vehicle charger 11 and a state in which the rapid charging device is connected to the battery 13 are both detected, or if neither are detected. The charging time calculation unit 57 calculates the charging time necessary for charging up to the capacity at the time of full charging from the currently remaining amount of the battery 13 through the selected charging method. The charging time calculation unit 57 notifies the obtained charging time to the charging control unit 59 and the display control unit 61.

In step S23, the display of the charging state starts, similar to the process of step S3.

In step S24, the vehicle 1 starts charging. Specifically, the charging control unit 59 selects either the normal charging or the rapid charging through a process similar to the process by the charging time calculation unit 57 of step S57. When the normal charging is selected, the charging control unit 59 instructs the start of charging to the in-vehicle charger 11 through the communication unit 51. Accompanied therewith, the normal charging of the battery 13 by the in-vehicle charger 11 starts. When the rapid charging is selected, the charging control unit 59 instructs the start of charging to the rapid charging device through the communication unit 51. Accompanied therewith, the rapid charging of the battery 13 by the rapid charging device starts.

In step S25, it is determined whether or not change of reservation is instructed, similar to the process of step S15. The process proceeds to step S26 if determined that the change of reservation is not instructed.

In step S26, the charging control unit 59 determines whether or not the stop of charging is instructed. The process proceeds to step S27 if determined that the stop of charging is not instructed.

In step S27, the charging control unit 59 determines whether or not the power supply for charging is detached based on the signal provided from the in-vehicle charger 11 through the communication unit 51. The process proceeds to step S28 if determined that the power supply for charging is not detached.

In step S28, the charging control unit 59 determines whether or not the charging end time is reached. The process proceeds to step S29 if determined that the charging end time is not reached.

In step S29, the charging control unit 59 determines whether or not the charging is completed. Specifically, the charging control unit 59 measures the voltage and the temperature of the battery 13, and determines whether or not the charging of the battery 13 is completed based on the measured voltage and temperature of the battery 13. The process returns to step S25 if determined that the charging is not yet completed.

Thereafter, the process of steps S25 to S29 are repeatedly executed until determined that the change of reservation is instructed in step S25, determined that the stop of charging is instructed in step S26, determined that the power supply for charging is detached in step S27, determined that the charging end time is reached in step S28, and determined that the charging is completed in step S29.

In step S26, the charging control unit 59 determines that the stop of charging is instructed when the user operates the input unit 19 and pushes the charging stop button 104 on the charging state display screen of FIG. 5, and the information thereof are provided to the charging control unit 59 through the communication unit 51 from the ECU 17, and the process proceeds to step S30.

If determined that the power supply for charging is detached in step S27, if determined that the charging end time is reached in step S28, or if determined that the charging is completed in step S29, the process proceeds to step S30.

In step S30, the in-vehicle charger 11 stops the charging. Specifically, when the normal charging is carried out, the charging control unit 59 instructs the stop of charging to the in-vehicle charger 11 through the communication unit 51. Accompanied therewith, the in-vehicle charger 11 stops the charging of the battery 13. When the rapid charging is carried out, the charging control unit 59 instructs the rapid charging device (not shown) to stop the charging. Accompanied therewith, the rapid charging device stops the charging of the battery 13. Thereafter, the charging process is terminated.

If determined that the change of reservation is instructed in step S25, the process proceeds to step S31.

In step S31, the charging is stopped, similar to the process of step S30. Thereafter, the process returns to step S6, and the processes after step S6 are executed.

The details of the manual timer reservation charging setting process of step S7 of FIG. 3 will now be described with reference to the flowchart of FIG. 7.

In step S51, the setting unit 52 instructs the setting of the manual timer reserved charging to the charging time calculation unit 57, the reservation time setting unit 58, the charging control unit 59, and the display control unit 61.

In step S52, the remaining amount of the battery 13 is measured, similar to the process of step S21 of FIG. 3.

In step S53, the charging time necessary for full charging is calculated, similar to the process of step S22 of FIG. 3.

In step S54, the display unit 18 displays the manual timer reserved charging setting screen. In other words, the display control unit 61 provides a command to the ECU 17 through the communication unit 51, and causes the display unit 18 to display the manual timer reserved charging setting screen.

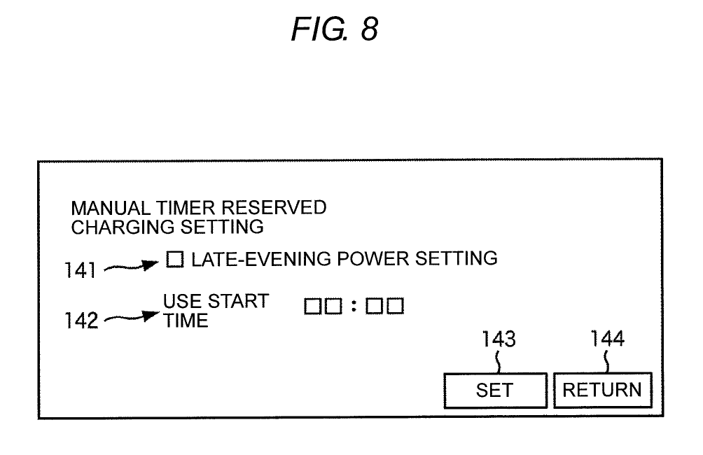

FIG. 8 shows one example of the manual timer reserved charging setting screen. A late-evening power setting field 141, a use start time setting field 142, a set button 143, and a return button 144 are displayed on the manual timer reserved charging setting screen.

The late-evening power setting field 141 is provided with a check box for setting ON or OFF of the late-evening power setting.

The use start time setting field 142 includes a field for inputting the use start time or a scheduled time to start the use of the vehicle 1.

The set button 143 is a button to be pushed when confirming the late-evening power setting and the setting of the use start time.

The return button 144 is a button to be pushed when returning to the previous charging mode setting screen of FIG. 6.

Returning back to FIG. 7, the setting unit 52 determines whether or not the set content is changed in step S55. Specifically, when the user operates the input unit 19, changes the late-evening power setting or the setting of the use start time on the manual timer reserved charging setting screen of FIG. 8, and the information are provided to the setting unit 52 through the communication unit 51 from the ECU 17, the setting unit 52 determines that the set content is changed, and the process proceeds to step S56.

In step S56, the setting unit 52 notifies the set content to the charging time calculation unit 57, the reservation time setting unit 58, the charging control unit 59, and the display control unit 61.

In step S57, the reservation time setting unit 58 determines whether or not the late-evening power setting is turned ON based on the notification from the setting unit 52. The process proceeds to step S58 if determined that the late-evening power setting is turned ON.

In step S58, the reservation time setting unit 58 determines whether or not the home power supply is connected. The process proceeds to step S59 if the reservation time setting unit 58 determines that the in-vehicle charger 11 is connected to the home power supply based on the signal provided from the in-vehicle charger 11 through the communication unit 51.

In step S59, the reservation time setting unit 58 determines whether or not charging is possible only in the late-evening power time zone. The reservation time setting unit 58 determines that charging is possible only in the late-evening power time zone when the length of the period (hereinafter referred to as late-evening power chargeable period) contained in the period from the current time to the use start time set by the user of the late-evening power time zone is greater than or equal to the charging time obtained by the charging time calculation unit 57, and the process proceeds to step S60.

For example, assuming the late-evening power time zone is a period from 11 PM to 7 AM, the current time is 9 PM, the use start time is 5 AM and the charging time is three hours, the late-evening power chargeable period is six hours from 11 PM to 5 AM, which is longer than the charging time of three hours. Therefore, in this case, determination is made that charging is possible only in the late-evening power time zone.

In step S60, the reservation time setting unit 58 sets the reservation time such that the charging is completed only in the late-evening power time zone. In other words, the reservation time setting unit 58 sets the charging start time when the charging of the battery 13 is to start and the charging end time when the charging is to end such that the charging is completed within the late evening power chargeable period. In the previous example, the charging start time is set between 11 PM and 2 AM and the charging end time is set three hours after the charging start time so that the charging is completed between 11 PM and 5 AM which is the late-evening power chargeable period.

In this case, the charging start time and the charging end time are set such that the charging end time is a time equal to the end time of the late-evening power chargeable period or the time close to the end time of the late-evening power chargeable period as much as possible, so that the time the battery 13 after charging is left is reduced, and the natural discharge of the battery 13 is further reduced.

The process then proceeds to step S62.

If determined that the late-evening power setting is turned OFF in step S57, if determined that the home power supply is not connected in step S58, or if determined that the charging is not possible only in the late-evening power time zone in step S59, the process proceeds to step S61.

In step S61, the reservation time setting unit 58 sets the reservation time so that charging is completed before the use start time. In other words, the reservation time setting unit 58 sets the charging start time to start the charging of the battery 13 between the current time and the time obtained by subtracting the charging time obtained from the charging time calculation unit 57 from the use start time (including current time and use start time), and sets the time elapsed by the charging time from the charging start time as the charging end time. For example, if the use start time is set at 6 AM, the obtained charging time is three hours, and the current time is 9 PM, the charging start time is set between 9 PM and 3 AM, and the charging end time is set three hours after the set charging start time.

In this case, the charging start time and the charging end time are set such that the charging end time is the time equal to the use start time or the time close to the use start time as much as possible, so that the time the battery 13 after charging is left is reduced, and the natural discharge of the battery 13 is further reduced.

If determined that the charging is not possible only in the late-evening power time zone in step S59, the reservation time may be assigned such that the late-evening power chargeable period can be used as much as possible in step S61. An electricity cost thus can be saved.

The process then proceeds to step S62.

If determined that the set content is not changed in step S55, the processes of steps S56 to S61 are skipped, and the process proceeds to step S62.

In step S62, the setting unit 52 determines whether or not an instruction to return to the setting of the charging mode is made. If determined that the instruction to return to the setting of the charging mode is not made, the process proceeds to step S63.

In step S63, the setting unit 52 determines whether or not the set content is confirmed. If determined that the set content is not confirmed, the process returns to step S55. Thereafter, the processes of steps S55 to S63 are repeatedly executed until it is determined that the instruction to return to the setting of the charging mode is made in step S62 or that the set content is confirmed in step S63.

In step S63, when the user operates the input unit 19 and pushes the set button 143 of the manual timer reserved charging setting screen of FIG. 8 so that the information is provided to the setting unit 52 through the communication unit 51 from the ECU 17, the setting unit 52 determines that the set content is confirmed, and the process proceeds to step S64.

In step S64, the reservation time setting unit 58 confirms the reservation. Specifically, the setting unit 52 notifies that the set content is confirmed to the charging time calculation unit 57, the reservation time setting unit 58, the charging control unit 59, and the display control unit 61. The reservation time setting unit 58 notifies the set charging start time and the charging end time to the charging control unit 59. Thereafter, the manual timer reserved charging setting process is terminated, and the process proceeds to step S14 of FIG. 4.

In step S63, when the user operates the input unit 19, and pushes the return button 144 of the manual timer reserved charging setting screen of FIG. 8 so that the information is provided to the setting unit 52 through the communication unit 51 from the ECU 17, the setting unit 52 determines that the instruction to return to the setting of the charging mode is made, and the process returns to step S6 of FIG. 3 so that the processes after step S6 are executed.

The details of the normal timer reserved charging setting process of step S9 of FIG. 3 will now be described with reference to the flowchart of FIG. 9.

In step S101, the setting unit 52 instructs the setting of the normal timer reserved charging to the charging time calculation unit 57, the reservation time setting unit 58, the charging control unit 59, and the display control unit 61.

In step S102, the remaining amount of the battery 13 is measured, similar to the process of step S21 of FIG. 3.

In step S103, the average traveling distance calculation unit 53 calculates the average traveling distance. Specifically, the charging time calculation unit 57 instructs the calculation of the necessary capacity to the necessary capacity calculation unit 55. The necessary capacity calculation unit 55 that received the instruction to calculate the necessary capacity instructs the average traveling distance calculation unit 53 to calculate the average traveling distance.

The average traveling distance calculation unit 53 acquires information on the traveling distance of the vehicle 1 from the ECU 17 through the communication unit 51 at a predetermined timing, and records the same with date and time. The average traveling distance calculation unit 53 obtains the average traveling distance of the vehicle 1 for a predetermined time (e.g., 24 hours or scheduled time from when the charging of this time is finished until the next charging is started) based on the record of the traveling distance of the vehicle 1 in a predetermined period (e.g., past one month). The average traveling distance calculation unit 53 notifies the obtained average traveling distance to the necessary capacity calculation unit 55 and the display control unit 61.

If the record of the traveling distance of the vehicle 1 is not present, a predetermined distance (e.g., travelable distance with rated capacity of battery 13) is obtained as the average traveling distance.

In step S104, the average battery consuming amount calculation unit 54 calculates the average battery consuming amount according to the instruction of the necessary capacity calculation unit 55. Specifically, the average battery consuming amount calculation unit 54 monitors the state of the battery 13, and records the consuming amount of the battery 13 with the date and time. The average battery consuming amount calculation unit 54 obtains, as the average battery consuming amount, the average of the consuming amount of the battery 13 of the vehicle 1 for a predetermined time (e.g., 24 hours or scheduled time from when the charging of this time is finished until the next charging is started) based on the record of the consuming amount of the battery in a predetermined period (e.g., past one month). The average battery consuming amount calculation unit 54 notifies the obtained average consuming amount to the necessary capacity calculation unit 55.

If the record of the consuming amount of the battery is not present, a predetermined capacity (e.g., rated capacity of battery 13) is obtained as the average battery consuming amount.

In step S105, the necessary capacity calculation unit 55 calculates the necessary capacity of the battery 13. Specifically, the necessary capacity calculation unit 55 acquires the information related to the fuel consumption of the vehicle 1 from the ECU 17 through the communication unit 51. The necessary capacity calculation unit 55 calculates the capacity of the battery 13 necessary for traveling the average traveling distance obtained by the average traveling distance calculation unit 53 based on the acquired fuel consumption of the vehicle 1. The necessary capacity calculation unit 55 calculates, as a capacity of the battery 13 necessary until the next charging, a value in which a predetermined margin is added to a greater value of the obtained capacity of the battery 13 or the average battery consuming amount obtained by the average battery consuming amount calculation unit 54. In other words, the capacity of the battery 13 necessary until the next charging is a value substantially equal to the capacity of the battery 13 necessary for the vehicle to travel for a predetermined time (e.g., 24 hours or scheduled time from when the charging of this time is finished until the next charging is started) or a value slightly greater than such a value. The necessary capacity calculation unit 55 notifies the obtained capacity of the battery 13 to the charging time calculation unit 57.

The necessary capacity of the battery 13 may be obtained based on either one of the average traveling distance or the average battery consuming amount.

In step S106, the charging time calculation unit 57 calculates the necessary charging time. Specifically, the charging time calculation unit 57 selects either the normal charging or the rapid charging, similar to the process of step S22 of FIG. 3. The charging time calculation unit 57 calculates the charging time necessary for charging up to the capacity obtained by the necessary capacity calculation unit 55 from the currently remaining amount of the battery 13 by the selected charging method. The charging time calculation unit 57 notifies the obtained charging time to the reservation time setting unit 58 and the display control unit 61.

In step S107, the display unit 18 displays the normal timer reserved charging setting screen. In other words, the display control unit 61 gives an instruction to the ECU 17 through the communication unit 51, and causes the display unit 18 to display the normal timer reserved charging setting screen.

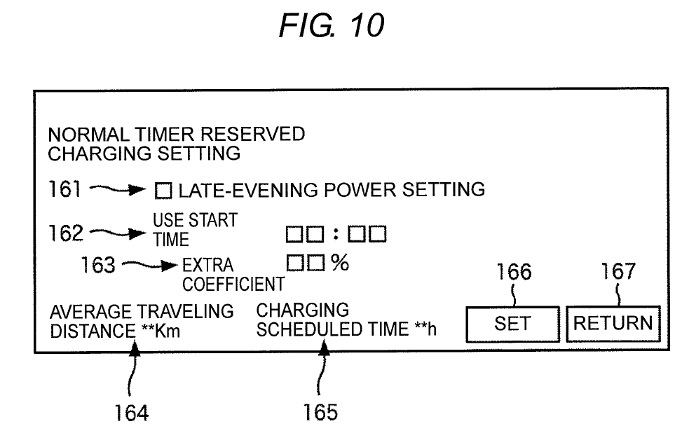

FIG. 10 shows one example of the normal timer reserved charging setting screen. A late-evening power setting field 161, a use start time setting field 162, an extra coefficient setting field 163, an average traveling distance display field 164, a charging scheduled time display field 165, a set button 166, and a return button 167 are displayed on the normal timer reserved charging setting screen of FIG. 10.

The late-evening power setting field 161 and the use start time setting field 162 are similar to the late-evening power setting field 141 and the use start time setting field 142 of the manual timer reserved charging setting screen of FIG. 8, and the description thereof will not be repeated.

The extra coefficient setting field 163 includes a field for inputting the extra coefficient used when extending the charging time in a case of charging using the late-evening power.

The average traveling distance display field 164 displays the average traveling distance of the vehicle 1 obtained by the average traveling distance calculation unit 53.

The charging scheduled time display field 165 displays the charging time of the battery 13 obtained by the charging time calculation unit 57.

The set button 162 is a button to be pushed when confirming the setting of the late-evening power setting, the use start time, and the extra coefficient.

The return button 167 is a button to be pushed when returning to the previous charging mode setting screen of FIG. 6.

Returning back to FIG. 9, the setting unit 52 determines whether or not the set content is changed in step S108. Specifically, when the user operates the input unit 19, and changes the setting of the late-evening power setting, the use start time, or the extra coefficient on the normal timer reserved charging setting screen of FIG. 10 so that the information is provided to the setting unit 52 through the communication unit 51 from the ECU 17, the setting unit 52 determines that the set content is changed and the process proceeds to step S109.

In step S109, the set content is notified, similar to the process of step S56 of FIG. 7.

In step S110, whether or not the late-evening power setting is turned ON is determined, similar to the process of step S57 of FIG. 7. If determined that the late-evening power setting is turned ON, the process proceeds to step S111.

In step S111, whether or not connected to the home power supply is determined, similar to the process of step S58 of FIG. 7. If determined as connected to the home power supply, the process proceeds to step S112.

In step S112, whether or not charging is possible only in the late-evening power time zone is determined, similar to the process of step S59 of FIG. 7. If determined that charging is possible only in the late-evening power time zone, the process proceeds to step S113.

In step S113, the charging time calculation unit 57 corrects the charging time. Specifically, the reservation time setting unit 58 instructs the charging time calculation unit 57 to correct the charging time. The charging time calculation unit 57 extends the charging time to the time in which the extra coefficient set by the user is multiplied to the charging time obtained in step S106. The charging time calculation unit 57 calculates the capacity of the battery 13 of when charged by the corrected charging time based on the currently remaining amount of the battery 13. The charging time calculation unit 57 corrects the charging time so as to be within the range of the rated capacity when the obtained capacity of the battery 13 is greater than the rated capacity. The charging time calculation unit 57 notifies the corrected charging time to the reservation time setting unit 58 and the display control unit 61.

In step S114, the reservation time is set such that the charging is completed only in the late-evening power time zone, similar to the process of step S60 of FIG. 7. The process thereafter proceeds to step S117.

If determined that the late-evening power setting is turned OFF in step S110, if determined that the home power supply is not connected in step S111, or if determined that the charging is not possible only in the late-evening power time zone in step S112, the process proceeds to step S115.

In step S115, the charging time calculation unit 57 returns the charging time to the value before correction. Specifically, the reservation time setting unit 58 instructs the charging time calculation unit 57 to return the charging time to the value before the correction. The charging time calculation unit 57 returns the charging time to the value obtained in step S106. The charging time calculation unit 57 notifies the charging time returned to the value before the correction to the reservation time setting unit 58 and the display control unit 61. The process of step S115 can be skipped if the charging time is not corrected in step S113.

In step S116, the reservation time is set so that charging is completed before the use start time, similar to the process of step S61 of FIG. 7. The process thereafter proceeds to step S117.

If determined that the set content is not changed in step S108, the processes of steps S109 to S116 are skipped, and the process proceeds to step S117.

In step S117, the setting unit 52 determines whether or not instructed to return to the setting of the charging mode. The process proceeds to step S118 if determined that the instruction to return to the setting of the charging mode is not made.

In step S118, the setting unit 52 determines whether or not the set content is confirmed. The process returns to step S108 if determined that the set content is not confirmed. Thereafter, the processes of steps S108 to S118 are repeatedly executed until determined that the instruction to return to the setting of the charging mode is made in step S117 or that the set content is confirmed in step S118.

In step S118, when the user operates the input unit 19 and pushes the set button 166 of the normal timer reserved charging setting screen of FIG. 10 so that the information is provided to the setting unit 52 through the communication unit 51 from the ECU 17, the setting unit 52 determines that the set content is confirmed, and the process proceeds to step S119.

In step S119, the reservation is confirmed, similar to the process of step S64 of FIG. 7, and the normal timer reserved charging setting process is terminated, and the process proceeds to step S14 of FIG. 4.

In step S117, when the user operates the input unit 19, and pushes the return button 167 of the normal timer reserved charging setting screen of FIG. 10 so that the information is provided to the setting unit 52 through the communication unit 51 from the ECU 17, the setting unit 52 determines that the instruction to return to the setting of the charging mode is made, and the process returns to step S6 of FIG. 3 so that the processes after step S6 are executed.

The details of the fixed charge fee timer reserved charging setting process of step S11 of FIG. 3 will be described with reference to the flowchart of FIG. 11.

In step S151, the setting unit 52 instructs the setting of the fixed charge fee timer reserved charging to the charging time calculation unit 57, the reservation time setting unit 58, the charging control unit 59, and the display control unit 61.

In step S152, the remaining amount of the battery 13 is measured, similar to the process of step S21 of FIG. 3.

In step S153, the display unit 18 displays the fixed charge fee timer reserved charging setting screen. In other words, the display control unit 61 causes the display unit 18 to display the fixed charge fee timer reserved charging setting screen while acquiring necessary information from each unit of the BMU 12.

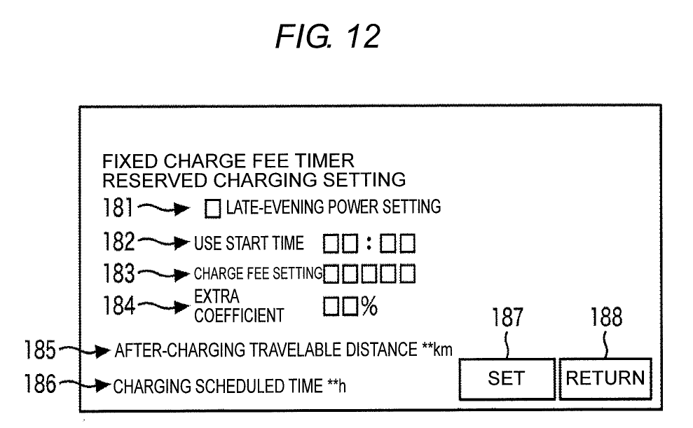

FIG. 12 shows one example of the fixed charge fee timer reserved charging setting screen. A late-evening power setting field 181, a use start time setting field 182, a charge fee setting field 183, an extra coefficient setting field 184, an after-charged travelable distance display field 185, a charging scheduled time display field 186, a set button 187, and a return button 188 are displayed in the fixed charge fee timer reserved charging setting screen of FIG. 12.

The late-evening power setting field 181 and the use start time setting field 182 are similar to the late-evening power setting field 141 and the use start time setting field 142 of the manual timer reserved charging setting screen of FIG. 8, and thus repetitive description thereof will not be repeated.

The charge fee setting field 183 is a field for inputting the upper limit of the electricity cost related to the charging of the battery 13 for one time.

The extra coefficient setting field 184 is similar to the extra coefficient setting field 163 of the normal timer reserved charging setting screen of FIG. 10, and thus description will not be repeated.

The after-charged travelable distance display field 185 displays the travelable distance of the charged vehicle 1 obtained by the travelable distance calculation unit 60.

The charging scheduled time display field 186 is similar to the charging scheduled time display field 165 of the normal timer reserved charging setting screen of FIG. 10, and thus description thereof will not be repeated.

The set button is a button to be pushed when confirming the setting of the late-evening power setting, the use start time, the charge fee setting, and the extra coefficient.

The return button 188 is a button to be pushed when returning to the previous charging mode setting screen of FIG. 6.

Returning back to FIG. 11, the setting unit 52 determines whether or not the set content is changed in step S154. Specifically, when the user operates the input unit 19, and changes the setting of the late-evening power setting, the use start time, the charge fee setting, or the extra coefficient on the fixed charge fee timer reserved charging setting screen of FIG. 12 so that the information is provided to the setting unit 52 through the communication unit 51 from the ECU 17, the setting unit 52 determines that the set content is changed and the process proceeds to step S155.

In step S155, the set content is notified, similar to the process of step S56 of FIG. 7.

In step S156, the charging time calculation unit 57 calculates the charging time that can be charged within the range of the set charge fee. Specifically, one of either the normal charging or the rapid charging is selected, similar to the process of step S22 of FIG. 3. The charging time calculation unit 57 calculates the charging time that can be charged within the range of the set charge fee by the selected charging method. The charging time calculation unit 57 also calculates the capacity of the battery 13 when charged by the obtained charging time based on the currently remaining amount of the battery 13. The charging time calculation unit 57 corrects the charging time so as to be within the range of the rated capacity when the obtained capacity of the battery 13 is greater than the rated capacity. The charging time calculation unit 57 notifies the obtained charging time to the reservation time setting unit 58.

In step S157, whether or not the late-evening power setting is turned ON is determined, similar to the process of step S57 of FIG. 7. The process proceeds to step S158 if determined that the late-evening power setting is turned ON.

In step S158, whether or not the home power supply is connected is determined, similar to the process of step S58 of FIG. 7. If determined that the home power supply is connected, the process proceeds to step S159.

In step S159, whether or not charging is possible only in the late-evening power time zone is determined, similar to the process of step S59 of FIG. 7. If determined that charging is possible only in the late-evening power time zone, the process proceeds to step S160.

In step S160, the charging time is corrected, similar to the process of step S113 of FIG. 9.

In step S161, the reservation time is set such that the charging is completed only in the late-evening power time zone, similar to the process of step S60 of FIG. 7. The process thereafter proceeds to step S163.

If determined that the late-evening power setting is turned OFF in step S157, if determined that the home power supply is not connected in step S158, or if determined that the charging is not possible only in the late-evening power time zone in step S159, the process proceeds to step S162.

In step S162, the reservation time is set so that charging is completed before the use start time, similar to the process of step S61 of FIG. 7. The process thereafter proceeds to step S163.

In step S163, the travelable distance calculation unit 60 estimates the travelable distance after charging. Specifically, the charging time calculation unit 57 notifies the capacity of the battery 13 after charging to the travelable distance calculation unit 60. The travelable distance calculation unit 60 acquires the information related to the fuel consumption of the vehicle 1 from the ECU 17 through the communication unit 51. The travelable distance calculation unit 60 estimates the distance the vehicle 1 can travel after charging based on the capacity of the battery 13 after charging, and the fuel consumption of the vehicle 1. The travelable distance calculation unit 60 notifies the estimated travelable distance to the display control unit 61.

If determined that the set content is not changed in step S154, the processes of steps S155 to S163 are skipped, and the process proceeds to step S164.

In step S164, the setting unit 52 determines whether or not instructed to return to the setting of the charging mode. The process proceeds to step S165 if determined that the instruction to return to the setting of the charging mode is not made.

In step S165, the setting unit 52 determines whether or not the set content is confirmed. The process returns to step S154 if determined that the set content is not confirmed. Thereafter, the processes of steps S154 to S165 are repeatedly executed until determined that the instruction to return to the setting of the charging mode is made in step S164 or that the set content is confirmed in step S165.

In step S165, when the user operates the input unit 19 and pushes the set button 187 of the fixed charge fee timer reserved charging setting screen of FIG. 12 so that the information is provided to the setting unit 52 through the communication unit 51 from the ECU 17, the setting unit 52 determines that the set content is confirmed, and the process proceeds to step S166.

In step S166, the reservation is confirmed, similar to the process of step S64 of FIG. 7, and the fixed charge fee timer reserved charging setting process is terminated, and the process proceeds to step S14 of FIG. 4.

In step S164, when the user operates the input unit 19, and pushes the return button 188 of the fixed charge fee timer reserved charging setting screen of FIG. 12 so that the information is provided to the setting unit 52 through the communication unit 51 from the ECU 17, the setting unit 52 determines that the instruction to return to the setting of the charging mode is made, and the process returns to step S6 of FIG. 3 so that the processes after step S6 are executed.

The details of the reservation time setting process of step S13 of FIG. 3 will now be described with reference to the flowcharts of FIGS. 13 and 14.

In step S201, the setting unit 52 instructs the setting of the reservation time to the charging time calculation unit 57, the reservation time setting unit 58, the charging control unit 59, and the display control unit 61.

In step S202, the remaining amount of the battery 13 is measured, similar to the process of step S21 of FIG. 3.

In step S203, the charging time calculation unit 57 determines whether or not it is set to the manual timer reserved charging mode. The process proceeds to step S204 if determined as set to the manual timer reserved charging mode.

In step S204, the charging time necessary for full charging is calculated, similar to the process of step S22 of FIG. 3. Thereafter, the process proceeds to step S211.

If determined as not set to the manual timer reserved charging mode in step S203, the process proceeds to step S205.

In step S205, the charging time calculation unit 57 determines whether or not it is set to the normal timer reserved charging mode. The process proceeds to step S206 if determined as set to the normal timer reserved charging mode.

In step S206, the average traveling distance is calculated, similar to the process of step S103 of FIG. 9.

In step S207, the average consuming amount of the battery 13 is calculated, similar to the process of step S104 of FIG. 9.

In step S208, the necessary capacity of the battery 13 is calculated, similar to the process of step S105 of FIG. 9.

In step S209, the necessary charging time is calculated, similar to the process of step S106 of FIG. 9. The process thereafter proceeds to step S211.

If determined as not set to the normal timer reserved charging mode instep S205, that is, if determined as set to the fixed charge fee timer reserved charging mode, the process proceeds to step S210.

In step S210, the charging time that can be charged within the set fee is calculated, similar to the process of step S156 of FIG. 11. The process then proceeds to step S211.

In step S211, whether or not the late-evening power setting is turned ON is determined, similar to the process of step S57 of FIG. 7. The process proceeds to step S212 if determined that the late-evening power setting is turned ON.

In step S212, whether or not the home power supply is connected is determined, similar to the process of step S58 of FIG. 7. The process proceeds to step S213 if determined as connected to the home power supply.

In step S213, whether or not charging is possible only in the late-evening power time zone is determined, similar to the process of step S59 of FIG. 7. The process proceeds to step S214 if determined that charging is possible only in the late-evening power time zone.

In step S214, the charging time calculation unit 57 determines whether or not the extra coefficient is set. The process proceeds to step S215 if determined that the extra coefficient is set.

In step S215, the charging time is corrected, similar to the process of step S113 of FIG. 9. The process then proceeds to step S216.

If determined that the extra coefficient is not set in step S214, the process of step S215 is skipped, and the process proceeds to step S216.

In step S216, the reservation time is set such that the charging is completed only in the late-evening power time zone. The process then proceeds to step S218.

If determined that the late-evening power setting is turned OFF in step S211, if determined that the home power supply is not connected in step S212, or if determined that the charging is not possible only in the late-evening power time zone in step S213, the process proceeds to step S217.

In step S217, the reservation time is set so that charging is completed before the use start time. The process then proceeds to step S218.

In step S218, the charging time calculation unit 57 determines whether or not set to the fixed charge fee timer reserved charging mode. The process proceeds to step S219 if determined as set to the fixed charge fee timer reserved charging mode.

In step S219, the distance that can be traveled after charging is estimated, similar to the process of step S163 of FIG. 11. The estimated travelable distance is notified from the travelable distance calculation unit 60 to the ECU 17 through the display control unit 61 and the communication unit 51, and displayed on the display unit 18, as necessary. The process then proceeds to step S220.

If determined as not set to the fixed charge fee timer reserved charging mode in step S218, the process of step S219 is skipped, and the process proceeds to step S220.

In step S220, the reservation is confirmed, similar to the process of step S64 of FIG. 7, and the reservation time setting process is terminated.

As described above, when reserving the charging of the battery 13, the charging amount of the battery 13 for one time can be selected according to the state and the usage status of each vehicle, the request of the user, and the like, and thus reserved charging of the battery 13 can be more appropriately carried out.

In particular, when set to the normal timer reserved charging mode, the charging time for one time can be suppressed as short as possible while ensuring the capacity of the battery 13 necessary for traveling the vehicle 1, and a power loss consumed in the ECU 17 and the like during the charging can be suppressed by suppressing the charging time for one time short.

When set to the fixed charge fee timer reserved charging mode, the electricity cost required for charging can be suppressed to lower than or equal to a desired value. Furthermore, the travelable distance after charging is displayed when set to the fixed charge fee timer reserved charging mode, whereby the user can sense in advance the lack of capacity of the battery 13 that may occur from suppressing the electricity cost.

When the late-evening power setting is set to ON, the battery 13 can be charged by preferentially using the late-evening power, which electricity cost is inexpensive, whereby the electricity cost can be saved. Furthermore, the battery 13 can be charged in extra if charging is possible in the late-evening power time zone by setting the extra coefficient, whereby the electricity cost can be further saved.

If a time zone in which the electricity cost is inexpensive exists other than the late-evening power time zone, a setting enabling the charging to be preferentially carried out in such a time zone may be provided.

The present invention can be applied to a device for controlling the charging of the battery of the vehicle, which uses a battery in at least one part of the power source, such as an electrical vehicle and a hybrid vehicle.

The series of processes described above may be executed by hardware or may be executed by software. When executing the series of processes by the software, the software is installed by being provided to a computer (CPU, ECU, BMC and the like) in which a program configuring the software is incorporated in dedicated hardware or a versatile personal computer capable of executing various types of functions by installing various types of programs through a program recording medium, or a wired or wireless transmission medium such as a local area network, the Internet, and a digital satellite broadcast.

The program executed by the computer may be a program in which the processes are performed in time-series along the order described herein, or may be a program in which the processes are performed in parallel or at a necessary timing such as when called out.

The embodiments of the present invention are not limited to the embodiments described herein, and various modifications may be made without departing from the scope of the invention.

In accordance with one aspect of the present invention, there is provided a charging control device for controlling charging of a battery, which is a power source of a vehicle, the charging control device including: a necessary capacity calculation unit for obtaining a necessary capacity, which is a necessary capacity of the battery, based on at least one of an average value of a traveling distance of the vehicle and an average value of a consuming amount of the battery for a predetermined time; a charging time calculation unit for obtaining a time necessary for charging from a currently remaining amount of the battery to the necessary capacity as a charging time; a reserved time setting unit for setting a charging start time of the battery between a current time and a time in which the charging time is subtracted from a set time set by a user, and setting a time the charging time elapsed from the charging start time as a charging end time; and a charging control unit for controlling to charge the battery from the set charging start time to the charging end time.

In the charging control device according to one aspect of the present invention, the necessary capacity, which is a necessary capacity of the battery, is obtained based on at least one of an average value of a traveling distance of the vehicle and an average value of a consuming amount of the battery for a predetermined time; a time necessary for charging from a currently remaining amount of the battery to the necessary capacity is obtained as a charging time; a charging start time of the battery is set between a current time and a time in which the charging time is subtracted from a set time set by a user, and a time the charging time elapsed from the charging start time is set as a charging end time; and control is performed to charge the battery from the set charging start time to the charging end time.

Therefore, the reserved charging of the battery, which is the power source of the vehicle, can be more appropriately performed. More specifically, the battery can be easily charged to the necessary capacity by the required time.

The necessary capacity calculation unit, the charging time calculation unit, the reserved time setting unit, and the charging control unit are configured by, for example, a BMU (Battery Management Unit), a CPU (Central Processing Unit), and an ECU (Electronic Control Unit).

The charging control device further includes: a setting unit for setting a charging mode indicating a method of reserved charging of the battery according to a command from the user; wherein the charging time calculation unit obtains a time necessary for charging from the currently remaining amount of the battery to the necessary capacity as the charging time when the charging mode is set to a first mode, and obtains a time necessary for charging from the currently remaining amount of the battery to a capacity at full charge as the charging time when the charging mode is set to a second mode.

The user thus can select whether to charge the battery to the necessary capacity or to charge the battery to full charge, and can perform the reserved charging of the battery more appropriately so as to comply with the desires of the user.

The setting unit is configured by, for example, a BMU (Battery Management Unit), a CPU (Central Processing Unit), and an ECU (Electronic Control Unit).

The charging control device further includes: a setting unit for setting a charging mode indicating a method of reserved charging of the battery according to a command from the user; wherein the charging time calculation unit obtains a time necessary for charging from the currently remaining amount of the battery to the necessary capacity as the charging time when the charging mode is set to a first mode, and obtains a time chargeable within a range of a charge fee set by the user when the charging mode is set to a second mode.

Thus the user can select whether to charge the battery to the necessary capacity or to charge within a range of the desired charge fee, and can perform the reserved charging of the battery more appropriately so as to comply with the desires of the user. Furthermore, the cost required to charge the battery can be suppressed to a desired range.

The setting unit is configured by, for example, a BMU (Battery Management Unit), a CPU (Central Processing Unit), and an ECU (Electronic Control Unit).

The charging control device further includes: a setting unit for setting ON or OFF of a time zone setting for performing charging preferentially in a predetermined time zone according to a command from the user; wherein the reserved time setting unit sets the charging start time and the charging end time so that charging is complete within a range of a time zone chargeable period if a length of the time zone chargeable period, which is a period included in a period from the current time to the set time of the time zone, is greater than or equal to the charging time when the time zone setting is turned ON.

Thus, the reserved charging of the battery can be performed only in the late-evening power time zone in which the electricity cost is low, whereby the cost required to charge the battery can be saved.

The setting unit is configured by, for example, a BMU (Battery Management Unit), a CPU (Central Processing Unit), and an ECU (Electronic Control Unit).

In accordance with another aspect of the present invention, the charging control method of one aspect of the present invention or the process to be executed by the computer according to the program of one aspect of the present invention is a charging control method of a device for controlling charging of a battery, which is a power source of a vehicle, or a process for controlling charging of a battery, which is a power source of a vehicle, and includes calculating and obtaining a necessary capacity, which is a necessary capacity of the battery, based on at least one of an average value of a traveling distance of the vehicle and an average value of a consuming amount of the battery for a predetermined time; calculating and obtaining a time necessary for charging from a currently remaining amount of the battery to the necessary capacity as a charging time; setting a charging start time of the battery between a current time and a time in which the charging time is subtracted from a set time set by a user, and setting a time the charging time elapsed from the charging start time as a charging end time; and controlling to charge the battery from the set charging start time to the charging end time.

In the charging control device or the program of one aspect of the present invention, the necessary capacity, which is a necessary capacity of the battery, is obtained based on at least one of an average value of a traveling distance of the vehicle and an average value of a consuming amount of the battery for a predetermined time; a time necessary for charging from a currently remaining amount of the battery to the necessary capacity is obtained as a charging time; a charging start time of the battery is set between a current time and a time in which the charging time is subtracted from a set time set by a user, and a time the charging time elapsed from the charging start time is set as a charging end time; and control is performed to charge the battery from the set charging start time to the charging end time.

Therefore, the reserved charging of the battery, which is the power source of the vehicle, can be more appropriately performed. More specifically, the battery can be easily charged to the necessary capacity by the required time.

The necessary capacity calculation step, the charging time calculation step, the reserved time setting step, and the charging control step are executed by a BMU (Battery Management Unit), a CPU (Central Processing Unit), and an ECU (Electronic Control Unit).

In accordance with one aspect of the present invention, the reserved charging of the battery, which is a power source of the vehicle, can be performed. In particular, according to one aspect of the present invention, the reserved charging of the battery, which is a power source of the vehicle, can be more appropriately performed.

What is claimed is:

1. A charging control device for controlling charging of a battery, which is a power source of a vehicle,
the charging control device comprising:
a necessary capacity calculation unit for obtaining a necessary capacity, which is a necessary capacity of the battery, based on at least one of an average value of a traveling distance of the vehicle and an average value of a consuming amount of the battery for a predetermined time;
a charging time calculation unit for obtaining a time necessary for charging from a currently remaining amount of the battery to the necessary capacity as a charging time;
a reserved time setting unit for setting a charging start time of the battery between a current time and a time in which the charging time is subtracted from a set time set by a user, and setting a time the charging time elapsed from the charging start time as a charging end time; and
a charging control unit for controlling to charge the battery from the set charging start time to the charging end time.

2. The charging control device according to claim 1, further comprising:
a setting unit for setting a charging mode indicating a method of reserved charging of the battery according to a command from the user; wherein
the charging time calculation unit obtains a time necessary for charging from the currently remaining amount of the battery to the necessary capacity as the charging time when the charging mode is set to a first mode, and obtains a time necessary for charging from the currently remaining amount of the battery to a capacity at full charge as the charging time when the charging mode is set to a second mode.

3. The charging control device according to claim 1, further comprising:
a setting unit for setting a charging mode indicating a method of reserved charging of the battery according to a command from the user; wherein
the charging time calculation unit obtains a time necessary for charging from the currently remaining amount of the battery to the necessary capacity as the charging time when the charging mode is set to a first mode, and obtains a time chargeable within a range of a charge fee set by the user when the charging mode is set to a second mode.

4. The charging control device according to claim 1, further comprising:
a setting unit for setting ON or OFF of a time zone setting for performing charging preferentially in a predetermined time zone according to a command from the user; wherein
the reserved time setting unit sets the charging start time and the charging end time so that charging is complete within a range of a time zone chargeable period if a length of the time zone chargeable period, which is a period included in a period from the current time to the set time of the time zone, is greater than or equal to the charging time when the time zone setting is turned ON.

5. A charging control method of a device for controlling charging of a battery, which is a power source of a vehicle,
the method comprising the steps of:
calculating and obtaining a necessary capacity, which is a necessary capacity of the battery, based on at least one of an average value of a traveling distance of the vehicle and an average value of a consuming amount of the battery for a predetermined time;
calculating and obtaining a time necessary for charging from a currently remaining amount of the battery to the necessary capacity as a charging time;
setting a charging start time of the battery between a current time and a time in which the charging time is subtracted from a set time set by a user, and setting a time the charging time elapsed from the charging start time as a charging end time; and
controlling to charge the battery from the set charging start time to the charging end time.

6. A program for causing a computer to execute the processes of:
calculating and obtaining a necessary capacity, which is a necessary capacity of the battery, based on at least one of an average value of a traveling distance of the vehicle and an average value of a consuming amount of the battery for a predetermined time;
calculating and obtaining a time necessary for charging from a currently remaining amount of the battery to the necessary capacity as a charging time;
setting a charging start time of the battery between a current time and a time in which the charging time is subtracted from a set time set by a user, and setting a time the charging time elapsed from the charging start time as a charging end time; and
controlling to charge the battery from the set charging start time to the charging end time.
